(19) United States
(12) Patent Application Publication
(10) Pub. No.: US 2018/0077417 A1
(43) Pub. Date: Mar. 15, 2018

(54) Method and Apparatus of Encoding Decision for Encoder Block Partition

(71) Applicant: MEDIATEK INC., Hsin-Chu (TW)

(72) Inventor: Han HUANG, San Jose, CA (US)

(21) Appl. No.: 15/700,215

(22) Filed: Sep. 11, 2017

(30) Foreign Application Priority Data
Sep. 14, 2016 (CN) PCT/CN2016/099021

(51) Int. Cl. H04N 19/157; H04N 19/105; H04N 19/119

(52) U.S. Cl. CPC H04N 19/157; H04N 19/119; H04N 19/105

(57) ABSTRACT

A method and apparatus for video coding using block partition are disclosed. According to the present invention, if a target block in the current image unit is generated from a first block partition as well as a second block partition, the coding information reuse is applied. According to the coding information reuse, a first set of coding parameters is determined for the target block generated from the first block partition. A second set of coding parameters is determined for the target block generated from the second block partition by reusing at least one encoder coding decision by the target block generated from the second block partition.

### CROSS REFERENCE TO RELATED APPLICATIONS

The present invention claims priority to PCT Provisional Patent Application, Serial No. PCT/CN2016/099021, filed on Sep. 14, 2016. The PCT Provisional Patent Application is hereby incorporated by reference in its entirety.

### FIELD OF THE INVENTION

The present invention relates to block partition for coding and/or prediction process in video coding. In particular, the present invention discloses an encoding method to reuse coding information from a target block resulted from one block partition by a same target block resulted from another one block partition.

### BACKGROUND AND RELATED ART

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC). In HEVC, one slice is partitioned into multiple coding tree units (CTU). In main profile, the minimum and the maximum sizes of CTU are specified by the syntax elements in the sequence parameter set (SPS). The allowed CTU size can be 8×8, 16×16, 32×32, or 64×64. For each slice, the CTUs within the slice are processed according to a raster scan order.

The CTU is further partitioned into multiple coding units (CU) to adapt to various local characteristics. A quadtree, denoted as the coding tree, is used to partition the CTU into multiple CUs. Let CTU size be M×M, where M is one of the values of 64, 32, or 16. The CTU can be a single CU (i.e., no splitting) or can be split into four smaller units of equal sizes (i.e., M/2×M/2 each), which correspond to the nodes of the coding tree. If units are leaf nodes of the coding tree, the units become CUs. Otherwise, the quadtree splitting process can be iterated until the size for a node reaches a minimum allowed CU size as specified in the SPS (Sequence Parameter Set). This representation results in a recursive structure as specified by a coding tree (also referred to as a partition tree structure) 120 in FIG. 1. The CTU partition 110 is shown in FIG. 1, where the solid lines indicate CU boundaries. The decision whether to code a picture area using Inter-picture (temporal) or Intra-picture (spatial) prediction is made at the CU level. Since the minimum CU size can be 8×8, the minimum granularity for switching between different basic prediction types is 8×8.

Furthermore, according to HEVC, each CU can be partitioned into one or more prediction units (PU). Coupled with the CU, the PU works as a basic representative block for sharing the prediction information. Inside each PU, the same prediction process is applied and the relevant information is transmitted to the decoder on a PU basis. A CU can be split into one, two or four PUs according to the PU splitting type. HEVC defines eight shapes for splitting a CU into PU as shown in FIG. 2, including 2N×2N, 2N×N, N×2N, N×N, 2N×nU, 2N×nD, nL×2N and nR×2N partition types. Unlike the CU, the PU may only be split once according to HEVC. The partitions shown in the second row correspond to asymmetric partitions, where the two partitioned parts have different sizes.

After obtaining the residual block by the prediction process based on PU splitting type, the prediction residues of a CU can be partitioned into transform units (TU) according to another quadtree structure which is analogous to the coding tree for the CU as shown in FIG. 1. The solid lines indicate CU boundaries and dotted lines indicate TU boundaries. The TU is a basic representative block having residual or transform coefficients for applying the integer transform and quantization. For each TU, one integer transform having the same size to the TU is applied to obtain residual coefficients. These coefficients are transmitted to the decoder after quantization on a TU basis.

The terms coding tree block (CTB), coding block (CB), prediction block (PB), and transform block (TB) are defined to specify the 2-D sample array of one color component associated with CTU, CU, PU, and TU, respectively. Thus, a CTU consists of one luma CTB, two chroma CTBs, and associated syntax elements. A similar relationship is valid for CU, PU, and TU. The tree partitioning is generally applied simultaneously to both luma and chroma, although exceptions apply when certain minimum sizes are reached for chroma.

Alternatively, a method to combine the quadtree and binary tree structure, which is also called as quadtree plus binary tree (QTBT) structure or QTBT partition, has been disclosed. According to the QTBT structure, a block is firstly partitioned by a quadtree structure and the quadtree splitting can be iterated until the size for a splitting block reaches the minimum allowed quadtree leaf node size. If the leaf quadtree block is not larger than the maximum allowed binary tree root node size, it can be further partitioned by a binary tree structure and the binary tree splitting can be iterated until the size (width or height) for a splitting block reaches the minimum allowed binary tree leaf node size (width or height) or the binary tree depth reaches the maximum allowed binary tree depth. In the QTBT structure, the minimum allowed quadtree leaf node size, the maximum allowed binary tree root node size, the minimum allowed binary tree leaf node width and height, and the maximum allowed binary tree depth can be indicated in the high level syntax such as in SPS. FIG. 3 illustrates an example of block partitioning 310 and its corresponding QTBT structure 320. The solid lines indicate quadtree splitting and dotted lines indicate binary tree splitting. In each splitting node (i.e., non-leaf node) of the binary tree, one flag indicates which splitting type (horizontal or vertical) is used, 0 may indicate horizontal splitting and 1 may indicate vertical splitting.

The above QTBT structure can be used for partitioning an image area (e.g. a slice, CTU or CU) into multiple smaller blocks such as partitioning a slice into CTUs, a CTU into CUs, a CU into PUs, or a CU into TUs, and so on. For example, the QTBT can be used for partitioning a CTU into CUs, where the root node of the QTBT is a CTU which is partitioned into multiple CUs by a QTBT structure and the CUs are further processed by prediction and transform coding. For simplification, there is no further partitioning from CU to PU or from CU to TU. That means CU equal to PU and PU equal to TU. Therefore, in other words, the leaf node of the QTBT structure is the basic unit for prediction and transform.

An example of QTBT structure is shown as follows. For a CTU with size 128×128, the minimum allowed quadtree leaf node size is set to 16×16, the maximum allowed binary tree root node size is set to 64×64, the minimum allowed binary tree leaf node width and height both is set to 4, and the maximum allowed binary tree depth is set to 4. Firstly, the CTU is partitioned by a quadtree structure and the leaf quadtree unit may have size from 16×16 (i.e., minimum allowed quadtree leaf node size) to 128×128 (equal to CTU size, i.e., no split). If the leaf quadtree unit is 128×128, it cannot be further split by binary tree since the size exceeds the maximum allowed binary tree root node size 64×64. Otherwise, the leaf quadtree unit can be further split by binary tree. The leaf quadtree unit, which is also the root binary tree unit, has binary tree depth as 0. When the binary tree depth reaches 4 (i.e., the maximum allowed binary tree as indicated), no splitting is implicitly implied. When the block of a corresponding binary tree node has width equal to 4, non-horizontal splitting is implicitly implied. When the block of a corresponding binary tree node has height equal to 4, non-vertical splitting is implicitly implied. The leaf nodes of the QTBT are further processed by prediction (Intra picture or Inter picture) and transform coding.

The QTBT tree structure is applied separately to luma and chroma components for I-slice, and applied simultaneously to both luma and chroma (except when certain minimum sizes being reached for chroma) for P- and B-slices. In other words, in an I-slice, the luma CTB has its QTBT-structured block partitioning and the two chroma CTBs have another QTBT-structured block partitioning. In another example, the two chroma CTBs can also have their own QTBT-structured block partitions.

For block-based coding, there is always a need to partition an image into blocks (e.g. CUs, PUs and TUs) for the coding purpose. As known in the field, the image may be divided into smaller images areas, such as slices, tiles, CTU rows or CTUs before applying the block partition. The process to partition an image into blocks for the coding purpose is referred as partitioning the image using a coding unit (CU) structure. The particular partition method to generate CUs, PUs and TUs as adopted by HEVC is an example of the coding unit (CU) structure. The QTBT tree structure is another example of the coding unit (CU) structure.

While the QTBT block partition offers flexibility to allow more possible partitions, it also increases the encoder complexity. In order to achieve good or best performance, the encoder has to evaluate coding parameters for various partition candidates and select one that achieves a best performance criterion, such as rate-distortion value. It is desirable to develop methods to reduce the encoder complexity when the QTBT block partition is enabled.

### BRIEF SUMMARY OF THE INVENTION

A method and apparatus for video coding using block partition are disclosed. According to the present invention, a current image unit of the current image is partitioning using block partitioning. If a target block in the current image unit is generated from a first block partition as well as a second block partition, the coding information reuse is applied, where the first block partition is different from the second block partition. According to the coding information reuse, a first set of coding parameters is determined for the target block generated from the first block partition. A second set of coding parameters is determined for the target block generated from the second block partition by reusing at least one encoder coding decision by the target block generated from the second block partition. First coding performance associated with coding the target block using the first set of coding parameters and second coding performance associated with coding the target block using the second set of coding parameters are evaluated. A target set of coding parameters for the target block based on a set of coding performances including the first coding performance and the second coding performance.

The block partition may correspond to quadtree plus binary tree (QTBT) partition. The encoder coding decision reused by the target block generated from the second block partition may comprise one or a combination of the following: a) Index indicating selection of Position Dependent Prediction Combination (PDPC); b) Flag indicating on/off of Enhanced Multiple Transform (EMT); c) Index indicating selection of transform in EMT; d) Index indicating selection of secondary transform as either Rotational transform (ROT) or non-separable secondary transform (NSST); e) Flag indicating on/off of reference sample smoothing or Reference Sample Adaptive Filter (RSAF); f) Index indicating selection of luma intra mode; g) Index indicating selection of chroma intra mode; h) Flag indicating on/off of Frame Rate Up Conversion (FRUC) mode; i) Index indicating selection of FRUC mode; j) Flag indicating on/off of integer motion vector (IMV); k) Flag indicating on/off of affine motion compensation mode; l) Flag indicating on/off of illumination compensation (IC); m) Flag indicating on/off of merge mode; n) Index indicating selection of merge candidate; o) Index indicating selection of inter prediction direction; p) Flags/index indicating selection of partition mode, quadtree split, horizontal binary split or vertical binary split; q) Motion vectors; and r) Affine motion parameters.

In the first example, the combination of encoder decision reuse may consist of PDPC index, EMT flag, EMT index and secondary transform index. In the second example, the combination of encoder decision reuse may further include FRUC flag, FRUC index, IMV flag, affine flag and IC flag in addition to the encoder decision reuse of the first example. In the third example, the combination of encoder decision reuse may further include merge flag in addition to the encoder decision reuse of the second example. In the fourth example, the combination of encoder decision reuse may further include inter prediction direction index in addition to the encoder decision reuse of the third example. In the fifth example, the combination of encoder decision reuse may further include flags and/or index indicating selection of partition mode, such as quadtree split, horizontal binary split or vertical binary split in addition to the encoder decision reuse of the fourth example.

In one embodiment, reusing said at least one encoder coding decision by the target block generated from the second block partition is applied if and only if coded neighboring blocks of the target block generated from the second block partition are the same as coded neighboring blocks of the target block generated from the first block partition. In another embodiment, said reusing said at least one encoder coding decision by the target block generated from the second block partition is applied if and only if the target block generated from the second block partition has same partition tree depth as the target block generated from the first block partition. Whether said reusing said at least one encoder coding decision by the target block generated from the second block partition is applied depends on a slice type of the current image unit. For example, the encoder decision reuse can be on for an Intra slice and off for an Inter slice.

### BRIEF DESCRIPTION OF THE DRAWINGS

FIG. 1 illustrates an example of block partition using quadtree structure to partition a coding tree unit (CTU) into coding units (CUs).

FIG. 2 illustrates asymmetric motion partition (AMP) according to High Efficiency Video Coding (HEVC), where the AMP defines eight shapes for splitting a CU into PU.

FIG. 3 illustrates an example of block partitioning and its corresponding quad-tree plus binary tree structure (QTBT), where the solid lines indicate quadtree splitting and dotted lines indicate binary tree splitting.

FIG. 4A illustrates an example that a target block “X” is resulted by partitioning a block vertically first followed by horizontal split on the upper block.

FIG. 4B illustrates an example that a target block “X” is resulted by partitioning a block horizontally first followed by vertical split on the left block.

FIG. 4C illustrates an example that a target block “X” is resulted by partitioning a block using quad-partition.

FIG. 5 illustrates a flowchart of an exemplary coding system using block partition, where if a target block can be generated from two different partitions, at least one encoder decision is reused for encoding the target block generated from two different partitions.

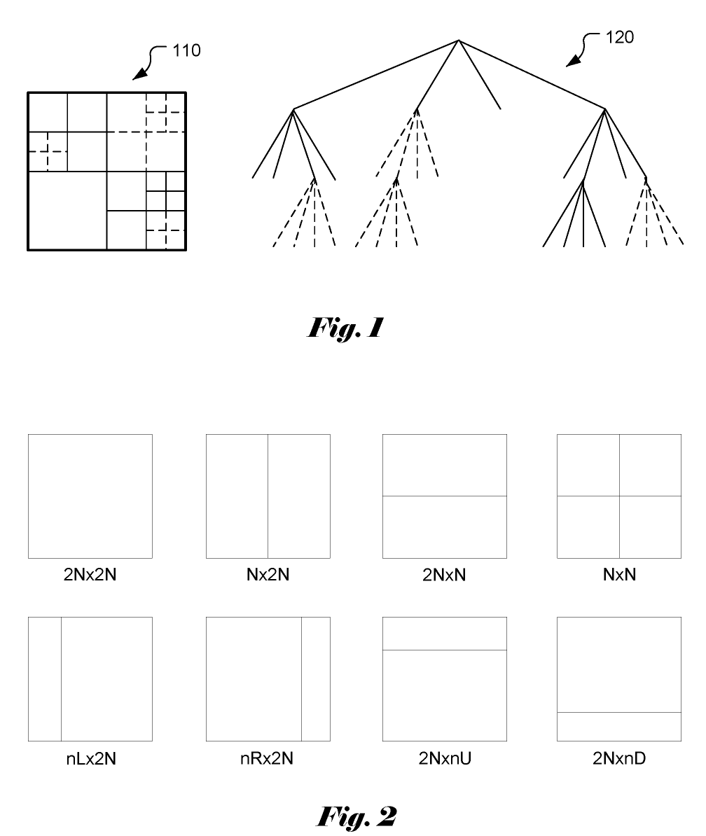

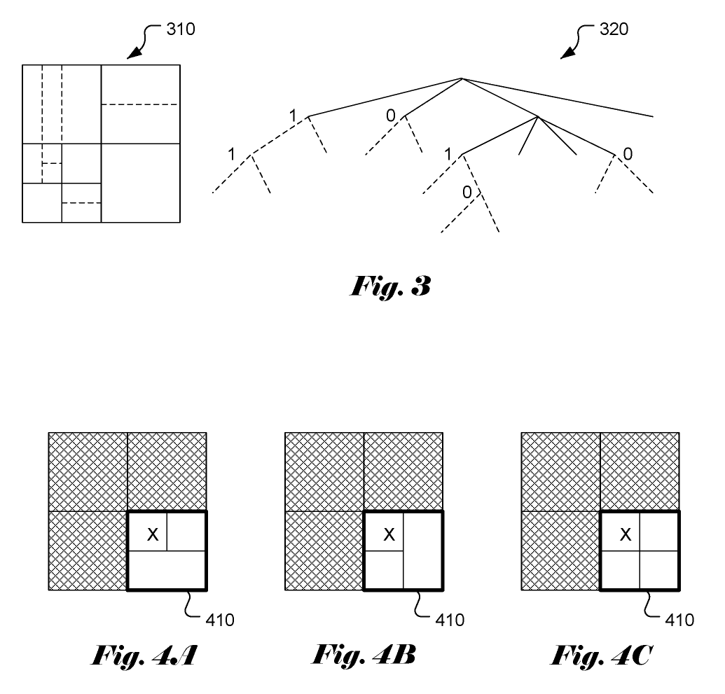

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

According to the existing video encoder using the QTBT structure, the encoder would evaluate the performance for each candidate block partition. For example, the rate-distortion values for all block partitions associated with a CTU or CU will be evaluated and the block partition that achieves the best performance will be selected by the encoder. During the performance evaluation, the blocks resulted from a target block partition will be encoded using a set of coding parameters to determine the performance, such as rate-distortion value.

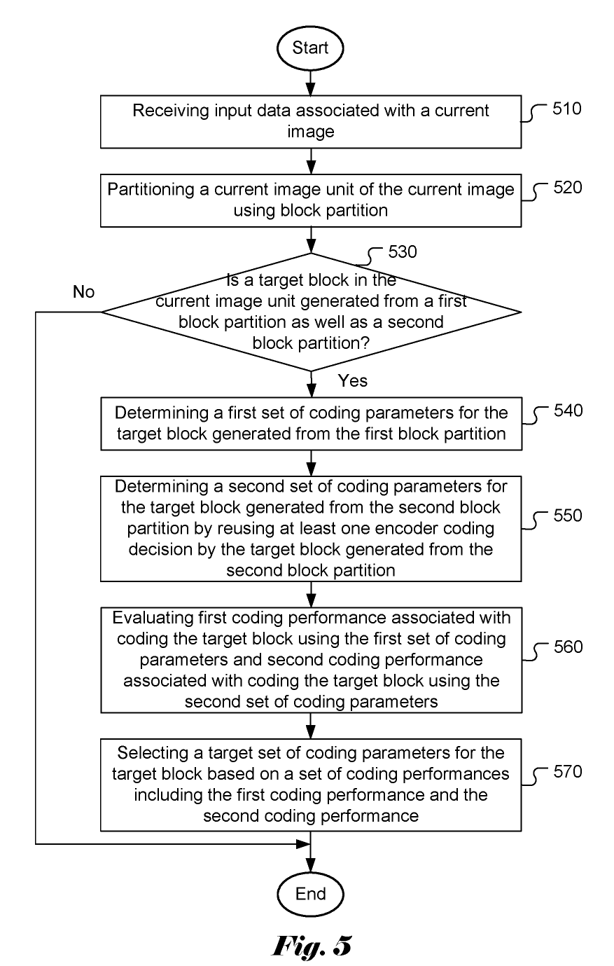

Due to the flexibility of QTBT partition, a same target block may be resulted from different block partitions. In FIG. 4A-FIG. 4C, an example is shown to demonstrate that a same target block (labelled as “X”) may be resulted from different block partitions. In FIG. 4A, target block “X” is resulted from partitioning block 410 (as indicated by thick line box) vertically first followed by horizontal split on the upper block. If block 410 corresponds to a 2N×2N block, the first splitting (i.e., vertical partition) will result in two 2N×N blocks. The second splitting is applied to the upper 2N×N block to result in two N×N blocks and the target block “X” corresponds to the left N×N block. In FIG. 4B, target block “X” is resulted from partitioning block 410 horizontally first followed by vertical split on the left block. In this case, the first splitting (i.e., horizontal partition) will result in two N×2N blocks. The second splitting is applied to the left N×2N block to result in two N×N blocks and the target block “X” corresponds to the upper N×N block. In FIG. 4C, target block “X” is resulted from partitioning block 410 using quad-partition. Therefore, a same target block may be resulted from different block partitions.

In a conventional approach, the same target block “X” resulted from three different block partitions would be evaluated separately. In other words, three individual coding parameter sets may have to be determined for the same target block “X” derived from three different block partitions. Therefore, the present invention discloses an encoder decision method that reuses the encoder decision of a target block generated from a first block partition for the encoder decision of a same target block generated from a second block partition. In the example of FIG. 4A-FIG. 4C, the block partition corresponds to QTBT partition. However, the present invention is not limited thereto. The block partition may also correspond to quadtree partition, binary tree partition, triple tree partition, or any combination of the foregoing partitions.

As is known in the field, the encoder may have to select a set of coding parameters to encode a given block. The coding parameters may include prediction mode (e.g. Inter or Intra), motion vector (MV) and quantization parameter (QP), which are well known in the video coding field. In newer video coding systems, more video encoding controls are available. For example, under the Joint Video Exploration Team (WET) of ITU-T SG 16 WP 3 and ISO/IEC JTC 1/SC 29/WG 11, development of future video coding standard is under way and various new coding features have been disclosed in JVET-C1001 (Jianle Chen, et al., “Algorithm Description of Joint Exploration Test Model 3 (JEM 3)”, JVET of ITU-T SG 16 WP 3 and ISO/IEC JTC 1/SC 29/WG 11, 32rd Meeting: 26 May-1 Jun. 2016, Document: JVET-C1001).

An Enhanced Multiple Transforms (EMT) technique is proposed for both Intra and Inter prediction residual. In EMT, an EMT flag in the CU-level flag may be signaled to indicate whether only the conventional DCT-2 or other non-DCT2 type transforms are used. If the CU-level EMT flag is signaled as 1 (i.e., indicating non-DCT2 type transforms), an EMT index in the CU level or the TU level can be signaled to indicate the non-DCT2 type transform selected for the TUs.

In JVET-C1001, a video encoder is allowed to apply a forward primary transform to a residual block followed by a secondary transform. After the secondary transform is applied, the transformed block is quantized. The secondary transform can be a rotational transform (ROT). Also non-separable secondary transform (NSST) can be used. A ROT/NSST index can be signaled to indicate the selected ROT or NSST secondary transform.

In JVET-C1001, Position Dependent Intra Prediction Combination (PDPC) coding tool is supported. PDPC is a post-processing for Intra prediction, which invokes a combination of HEVC Intra prediction with un-filtered boundary reference samples. A CU level flag in signaled to indicate whether PDPC is applied or not. At the encoder side, the PDPC flag for an Intra-coded CU is determined at the CU level. When Intra mode Rate-Distortion (RD) cost check is needed for a CU, one additional CU level RD check is added to select the optimal PDPC flag between the value of 0 and 1 for an Intra-coded CU.

In JVET-C1001, a pattern matched motion vector derivation based on Frame-Rate Up Conversion (FRUC) techniques is used to derive MV candidate for merge mode. Both encoder and decoder can derive the pattern matched MV candidate in a same manner. Therefore, there is no need to signal the motion information of a block. A FRUC flag is signaled for a CU when its merge flag is true. When the FRUC flag is false, a merge index is signaled and the regular merge mode is used. When the FRUC flag is true, an additional FRUC mode flag is signaled to indicate which method (i.e., bilateral matching or template matching) is to be used to derive motion information for the block. At the encoder side, the decision on whether to use FRUC merge mode for a CU is based on R-D cost selection as done for normal merge candidate.

In JVET-C1001, Adaptive Motion Vector Resolution (AMVR) mode is allowed, where Motion Vector Difference (MVD) can be coded with either quarter-pel resolution or integer-pel resolution. The MVD resolution is controlled at coding unit (CU) level and an integer MVD resolution flag (e.g. IMV flag) is conditionally signaled for each CU that has at least one non-zero MVD components. When the IMV flag is false, or not coded for a CU, the default quarter-pel MV resolution is used for all PUs belonging to the CU. When IMV flag is true for a CU, all PUs coded with AMVP mode belonging to the CU use integer MV resolution, while the PUs coded with merge mode still use quarter-pel MV resolution. When a PU uses integer MV resolution, the AMVP candidate list is filled with integer MV by rounding quarter-pel MVs to integer-pel MVs.

In JVET-C1001, Illumination Compensation (IC) is introduced to compensate the illumination differences between two images. The illumination compensation can be performed locally on a block basis. Illumination compensation is based on a linear model for illumination changes, using a scaling factor and an offset value. IC is enabled or disabled adaptively for each Inter-mode coded coding unit (CU). An IC flag is used to indicate whether the IC is applied to the block. Also, a higher level IC flag may be used. The IC flag can be derived at the encoder side and signaled explicitly or implicitly.

Affine motion compensation prediction is yet another new coding tool used in JVET-C1001. In particular, a simplified affine transform motion compensation prediction is applied to improve the coding efficiency. An Affine flag in the CU level is signaled in the bitstream to indicate whether affine motion compensation mode is used.

A reference sample adaptive filter (RSAF) is yet another new coding tool used in JVET-C1001. This adaptive filter segments reference samples before smoothing to apply different filters to different segments. A flag may be signaled to indicate whether RSAF is on or off.

Beside the newer coding features mentioned above, a coding system often also includes various conventional coding features such as merge mode, Inter prediction mode and Intra mode for luma and chroma components. In the merge mode, a current block may use the same motion information as a merge candidate block, which is identified by a merge flag and a merge index. At the decoder side, a same merge candidate list is maintained so that the selected merge candidate can be identified by the merge index.

When Inter prediction mode is used, the encoder may select forward, backward or bidirectional prediction. Therefore, a parameter for Inter prediction direction is used to indicate the selected Inter prediction direction.

In order to achieve good or best coding performance, the encoder has to evaluate coding performance among various coding parameters and selects a set of coding parameters that achieves good or best performance. The allowable coding parameter set could be rather large. In practice, not every coding parameter will be evaluated. For example, in an environment that the illumination condition is fixed, the encoder may not need to derive the IC parameters. In another example, the encoder may be configured to generate bitstream for low delay applications. In this case, the encoder may always choose a forward prediction mode and there is no need to evaluate other Inter prediction direction. While only a selected set of coding tools may be used, determining the coding parameters jointly with the large number of possible QTBT partitions for good or best coding performance still poses a challenging issue on the encoder design. Accordingly, the present invention discloses methods for reducing computational complexity for the encoder when QTBT partitioning is used.

As shown in FIG. 4A-FIG. 4C, a same target block can be generated from different QTBT partitions. In a conventional approach, the same target block “X” resulted from three different block partitions would be evaluated separately. The present invention discloses an encoder decision method that reuses the encoder decision of a target block generated from a first QTBT partition process for the encoder decision of a same target block generated from a second QTBT partition process.

In one embodiment, the encoder decision includes one or a combination of the following encoder decisions:
Index indicating the selection of Position Dependent Prediction Combination (PDPC).
Flag indicating on/off of Enhanced Multiple Transform (EMT).
Index indicating the selection of transform in EMT.
Index indicating the selection of secondary transforms, either Rotational Transform (ROT) or Non-Separable Secondary Transform (NSST).
Flag indicating on/off of reference sample smoothing or Reference Sample Adaptive Filter (RSAF).
Index indicating the selection of luma Intra mode.
Index indicating the selection of chroma Intra mode.
Flag indicating on/off of Frame Rate Up Conversion (FRUC) mode.
Index indicating selection of FRUC mode.
Flag indicating on/off of integer motion vector (IMV).
Flag indicating on/off of affine motion compensation mode.
Flag indicating on/off of illumination compensation (IC).
Flag indicating on/off of merge mode.
Index indicating selection of merge candidate.
Index indicating selection of Inter prediction direction.
Flags/index indicating selection of partition mode, such as quadtree split, horizontal binary split or vertical binary split.
Motion vectors (MVs).
Affine motion parameters.

In the first example, the combination of reused encoder decisions may consist of PDPC index, EMT flag, EMT index and secondary transform index. In the second example, the combination of reused encoder decisions may further include FRUC flag, FRUC index, IMV flag, and affine flag and IC flag in addition to the reused encoder decisions of the first example. In the third example, the combination of reused encoder decisions may further include merge flag in addition to the reused encoder decisions of the second example. In the fourth example, the combination of reused encoder decisions may further include Inter prediction direction index in addition to the reused encoder decisions of the third example. In the fifth example, the combination of reused encoder decisions may further include flags and/or index indicating selection of partition mode, such as quadtree split, horizontal binary split or vertical binary split in addition to the reused encoder decisions of the fourth example.

In another embodiment, reuse of encoder decision in the same block generated by a second block partition process is applied if and only if the block generated from the second block partition has the same partition tree depth as the block generated from the first block partition. For example, if the binary tree depth of the target block “X” generated from a first QTBT partition as shown in FIG. 4A, the binary tree depth of the target block “X” generated from a second QTBT partition as shown in FIG. 4B and the binary tree depth of the target block “X” generated from a third QTBT partition as shown in FIG. 4C are the same, the encoder decision of the target block “X” generated from the first QTBT partition can be reused by the same target block “X” generated from the second QTBT partition and/or the same target block “X” generated from the third QTBT partition.

In yet another embodiment, reuse of encoder decision in the same block generated by a second QTBT partition process is applied if and only if the coded neighboring blocks of the target block generated from the second block partition are the same as the coded neighboring blocks of the target block generated from the first block partition. For example, the coded neighboring blocks of the target block “X” resulted from three different block partitions as shown in FIG. 4A-FIG. 4C are the same (i.e., the block above the block 410, the block left to the block 410, and the above left block of the block 410), so the encoder decision of the target block “X” generated from a first QTBT partition as shown in FIG. 4A can be reused by the same target block “X” generated from a second QTBT partition as shown in FIG. 4B and/or the same target block “X” generated from a third QTBT partition as shown in FIG. 4C.

In still another embodiment, reuse of some encoder decision depends on the slice type. For example, the index indicating the split decision is reused in the Intra slice, but not reused in the Inter slice.

FIG. 5 illustrates a flowchart of an exemplary coding system using block partition, where if a target block can be generated from two different partitions, at least one encoder decision is reused for encoding the target block generated from two different partitions. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current image are received in step 510. A current image unit of the current image is partitioned using block partition in step 520, in which the block partition can be one or a combination of quadtree plus binary tree (QTBT) partition, quadtree partition, binary tree partition and triple tree partition. Whether a target block in the current image unit is generated from a first block partition as well as a second block partition is checked in step 530. If the test result in step 530 is “yes”, steps 540 through 570 are performed. Otherwise (i.e., the test result in step 530 being “no”), steps 540 through 570 are skipped. In step 540, a first set of coding parameters for the target block generated from the first block partition is determined. In step 550, a second set of coding parameters for the target block generated from the second block partition is determined by reusing at least one encoder coding decision by the target block generated from the second block partition. In step 560, first coding performance associated with coding the target block is evaluated using the first set of coding parameters and second coding performance associated with coding the target block is evaluated using the second set of coding parameters. The well-known rate-distortion (R-D) optimization procedure can be used to select the best coding mode by comparing the coding performances associated with various coding modes. In step 570, a target set of coding parameters is selected for the target block based on a set of coding performances including the first coding performance and the second coding performance.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

In still another embodiment, the above presented methods can also be applied to other flexible block partition variants, as long as a target block can be generated by two or more different partitions.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video encoding used by a video encoding system, the method comprising:
receiving input data associated with a current image;
partitioning a current image unit of the current image using block partition;
if a target block in the current image unit is generated from a first block partition as well as a second block partition, wherein the first block partition is different from the second block partition:
determining a first set of coding parameters for the target block generated from the first block partition;
determining a second set of coding parameters for the target block generated from the second block partition by reusing at least one encoder coding decision by the target block generated from the second block partition;
evaluating first coding performance associated with coding the target block using the first set of coding parameters and second coding performance associated with coding the target block using the second set of coding parameters; and
selecting a target set of coding parameters for the target block based on a set of coding performances including the first coding performance and the second coding performance.

2. The method of claim 1, wherein the block partition corresponds to quadtree plus binary tree (QTBT) partition.

3. The method of claim 1, wherein said at least one encoder coding decision reused by the target block generated from the second block partition comprises one or a combination of the following:
a) Index indicating selection of Position Dependent Prediction Combination (PDPC);
b) Flag indicating on/off of Enhanced Multiple Transform (EMT);
c) Index indicating selection of transform in EMT;
d) Index indicating selection of secondary transform as either Rotational transform (ROT) or non-separable secondary transform (NSST);
e) Flag indicating on/off of reference sample smoothing or Reference Sample Adaptive Filter (RSAF);
f) Index indicating selection of luma intra mode;
g) Index indicating selection of chroma intra mode;
h) Flag indicating on/off of Frame Rate Up Conversion (FRUC) mode;
i) Index indicating selection of FRUC mode;
j) Flag indicating on/off of integer motion vector (IMV);
k) Flag indicating on/off of affine motion compensation mode;
l) Flag indicating on/off of illumination compensation (IC);
m) Flag indicating on/off of merge mode;
n) Index indicating selection of merge candidate;
o) Index indicating selection of inter prediction direction;
p) Flags/index indicating selection of partition mode, quadtree split, horizontal binary split or vertical binary split;
q) Motion vectors; and
r) Affine motion parameters.

4. The method of claim 1, wherein said at least one encoder coding decision reused by the target block generated from to the second block partition consists of PDPC index indicating selection of Position Dependent Prediction Combination (PDPC), EMT flag indicating on/off of Enhanced Multiple Transform (EMT), EMT index indicating selection of transform in EMT and secondary transform index indicating selection of secondary transform as either Rotational transform (ROT) or non-separable secondary transform (NSST).

5. The method of claim 1, wherein said at least one encoder coding decision reused by the target block generated from the second block partition consists of PDPC index indicating selection of Position Dependent Prediction Combination (PDPC), EMT flag indicating on/off of Enhanced Multiple Transform (EMT), EMT index indicating selection of transform in EMT, secondary transform index indicating selection of secondary transform as either Rotational transform (ROT) or non-separable secondary transform (NSST), FRUC flag indicating on/off of Frame Rate Up Conversion (FRUC) mode, FRUC index indicating selection of FRUC mode, IMV flag indicating on/off of integer motion vector (IMV), affine flag indicating on/off of affine motion compensation mode and IC flag indicating on/off of illumination compensation (IC).

6. The method of claim 1, wherein said at least one encoder coding decision reused by the target block generated from the second block partition consists of PDPC index indicating selection of Position Dependent Prediction Combination (PDPC), EMT flag indicating on/off of Enhanced Multiple Transform (EMT), EMT index indicating selection of transform in EMT, secondary transform index indicating selection of secondary transform as either Rotational transform (ROT) or non-separable secondary transform (NSST), FRUC flag indicating on/off of Frame Rate Up Conversion (FRUC) mode, FRUC index indicating selection of FRUC mode, IMV flag indicating on/off of integer motion vector (IMV), affine flag indicating on/off of affine motion compensation mode, IC flag indicating on/off of illumination compensation (IC) and merge flag indicating on/off of merge mode.

7. The method of claim 1, wherein said at least one encoder coding decision reused by the target block generated from the second block partition consists of PDPC index indicating selection of Position Dependent Prediction Combination (PDPC), EMT flag indicating on/off of Enhanced Multiple Transform (EMT), EMT index indicating selection of transform in EMT, secondary transform index indicating selection of secondary transform as either Rotational transform (ROT) or non-separable secondary transform (NSST), FRUC flag indicating on/off of Frame Rate Up Conversion (FRUC) mode, FRUC index indicating selection of FRUC mode, IMV flag indicating on/off of integer motion vector (IMV), affine flag indicating on/off of affine motion compensation mode, IC flag indicating on/off of illumination compensation (IC), merge flag indicating on/off of merge mode and Inter prediction direction index indicating selection of Inter prediction direction.

8. The method of claim 1, wherein said at least one encoder coding decision reused by the target block generated from the second block partition consists of PDPC index indicating selection of Position Dependent Prediction Combination (PDPC), EMT flag indicating on/off of Enhanced Multiple Transform (EMT), EMT index indicating selection of transform in EMT, secondary transform index indicating selection of secondary transform as either Rotational transform (ROT) or non-separable secondary transform (NSST), FRUC flag indicating on/off of Frame Rate Up Conversion (FRUC) mode, FRUC index indicating selection of FRUC mode, IMV flag indicating on/off of integer motion vector (IMV), affine flag indicating on/off of affine motion compensation mode, IC flag indicating on/off of illumination compensation (IC), merge flag indicating on/off of merge mode, Inter prediction direction index indicating selection of Inter prediction direction and partition flag or index indicating selection of partition mode among quadtree split, horizontal binary split or vertical binary split.

9. The method of claim 1, wherein said reusing said at least one encoder coding decision by the target block generated from the second block partition is applied if and only if coded neighboring blocks of the target block generated from the second block partition are the same as coded neighboring blocks of the target block generated from the first block partition.

10. The method of claim 1, wherein said reusing said at least one encoder coding decision by the target block generated from the second block partition is applied if and only if the target block generated from the second block partition has same partition tree depth as the target block generated from the first block partition.

11. The method of claim 1, wherein whether said reusing said at least one encoder coding decision by the target block generated from the second block partition is applied depends on a slice type of the current image unit.

12. The method of claim 11, wherein said reusing said at least one encoder coding decision by the target block generated from the second block partition is applied if the slice type of the current image unit is an Intra slice and said reusing said at least one encoder coding decision by the target block generated from the second block partition is not applied if the slice type of the current image unit is an Inter slice.

13. An apparatus of video encoding used by a video encoding system, the apparatus comprising one or more electronic circuits or processors arrange to:
receive input data associated with a current image;
partition a current image unit of the current image using block partition;
if a target block in the current image unit is generated from a first block partition as well as a second block partition, wherein the first block partition is different from the second block partition:
determine a first set of coding parameters for the target block generated from the first block partition;
determine a second set of coding parameters for the target block generated from the second block partition by reusing at least one encoder coding decision by the target block generated from the second block partition;
evaluate first coding performance associated with coding the target block using the first set of coding parameters and second coding performance associated with coding the target block using the second set of coding parameters; and
select a target set of coding parameters for the target block based on a set of coding performances including the first coding performance and the second coding performance.

14. The apparatus of claim 13, wherein said at least one encoder coding decision reused by the target block generated from the second block partition comprises one or a combination of the following:
a) Index indicating selection of Position Dependent Prediction Combination (PDPC);
b) Flag indicating on/off of Enhanced Multiple Transform (EMT);
c) Index indicating selection of transform in EMT;
d) Index indicating the selection of secondary transform, either Rotational transform (ROT) or non-separable secondary transform (NSST);
e) Flag indicating on/off of reference sample smoothing or Reference Sample Adaptive Filter (RSAF);
f) Index indicating selection of luma intra mode;
g) Index indicating selection of chroma intra mode;
h) Flag indicating on/off of Frame Rate Up Conversion (FRUC) mode;
i) Index indicating selection of FRUC mode;
j) Flag indicating on/off of integer motion vector (IMV);
k) Flag indicating on/off of affine motion compensation mode;
l) Flag indicating on/off of illumination compensation (IC);
m) Flag indicating on/off of merge mode;
n) Index indicating selection of merge candidate;
o) Index indicating selection of inter prediction direction;
p) Flags/index indicating selection of partition mode, quadtree split, horizontal binary split or vertical binary split;
q) Motion vectors; and
r) Affine motion parameters.

15. The apparatus of claim 13, wherein said reusing said at least one encoder coding decision by the target block generated from the second block partition is applied if and only if coded neighboring blocks of the target block generated from the second block partition are the same as coded neighboring blocks of the target block generated from the first block partition.

16. The apparatus of claim 13, wherein said reusing said at least one encoder coding decision by the target block generated from the second block partition is applied if and only if the target block generated from the second block partition has same partition tree depth as the target block generated from the first block partition.

17. The apparatus of claim 13, wherein whether said reusing said at least one encoder coding decision by the target block generated from the second block partition is applied depends on a slice type of the current image unit.

18. The apparatus of claim 17, wherein said reusing said at least one encoder coding decision by the target block generated from the second block partition is applied if the slice type of the current image unit is an Intra slice and said reusing said at least one encoder coding decision by the target block generated from the second block partition is not applied if the slice type of the current image unit is an Inter slice.

19. The apparatus of claim 13, wherein said at least one encoder coding decision reused by the target block generated from the second block partition consists of PDPC index indicating selection of Position Dependent Prediction Combination (PDPC), EMT flag indicating on/off of Enhanced Multiple Transform (EMT), EMT index indicating selection of transform in EMT and secondary transform index indicating selection of secondary transform as either Rotational transform (ROT) or non-separable secondary transform (NSST).

20. The apparatus of claim 13, wherein said at least one encoder coding decision reused by the target block generated from the second block partition consists of PDPC index indicating selection of Position Dependent Prediction Combination (PDPC), EMT flag indicating on/off of Enhanced Multiple Transform (EMT), EMT index indicating selection of transform in EMT, secondary transform index indicating selection of secondary transform as either Rotational transform (ROT) or non-separable secondary transform (NSST), FRUC flag indicating on/off of Frame Rate Up Conversion (FRUC) mode, FRUC index indicating selection of FRUC mode, IMV flag indicating on/off of integer motion vector (IMV), affine flag indicating on/off of affine motion compensation mode and IC flag indicating on/off of illumination compensation (IC).

21. The apparatus of claim 13, wherein said at least one encoder coding decision reused by the target block generated from the second block partition consists of PDPC index indicating selection of Position Dependent Prediction Combination (PDPC), EMT flag indicating on/off of Enhanced Multiple Transform (EMT), EMT index indicating selection of transform in EMT, secondary transform index indicating selection of secondary transform as either Rotational transform (ROT) or non-separable secondary transform (NSST), FRUC flag indicating on/off of Frame Rate Up Conversion (FRUC) mode, FRUC index indicating selection of FRUC mode, IMV flag indicating on/off of integer motion vector (IMV), affine flag indicating on/off of affine motion compensation mode, IC flag indicating on/off of illumination compensation (IC) and merge flag indicating on/off of merge mode.
